(19) United States
(12) Patent Application Publication
(10) Pub. No.: US 2003/0037280 A1
(43) Pub. Date: Feb. 20, 2003

(54) Computer memory error management system and method

(76) Inventors: Jerry D. Berg, Hayward, CA (US); Marian M. Choy, Mountain View, CA (US)

Correspondence Address: WAGNER, MURABITO & HAO LLP, Third Floor, Two North Market Street, San Jose, CA, 95113, US

(21) Appl. No.: 09/933,603

(22) Filed: Aug. 20, 2001

(51) Int. Cl. H04L 1/22

(52) U.S. Cl. 714/6

(57) ABSTRACT

The present invention is a computer memory error management system and method that facilitates fault tolerant memory I/O in a manner that permits smooth and continuous operations. The system and method handles memory control buffer corruption concerns associated with memory errors and corrects single bit errors. Information is placed in a memory controller buffer and a determination is made if a correctable error or non-correctable error exists in the information. If the error is a correctable error it is corrected in-line. A memory cell error resolution process is performed and information is rewritten to a memory control buffer location. If rewriting to the same memory controller buffer location does not solve the error, a hard error handling process is performed. A hard error handling process and a non-correctable error handling process utilize a fail over process in which an alternate memory controller performs the I/O operations.

### FIELD OF THE INVENTION

This invention relates to the field of information storage systems. More particularly, embodiments of the present invention relate to systems and methods for providing fault tolerant memory error management.

### BACKGROUND OF THE INVENTION

Electronic systems and circuits have made a significant contribution towards the advancement of modem society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Realizing these advantageous results frequently requires systems to manipulate very large amounts of information. In complex systems the bulk of the information is often stored in auxiliary physical memory devices or systems (such as a memory disk array system). The information is communicated back and forth between a host computer system and the auxiliary physical storage system. While auxiliary physical memory systems typically provide advantageous large scale information storage, errors sometimes occur in the communication of information to and from the physical memory system. These errors often have detrimental impacts on the operations and functionality of the computer system.

Traditional auxiliary physical storage systems typically cannot tolerate memory error faults and the memory error faults usually have significant detrimental impacts to functionality and utility of a system. Traditional memory error failure modes often result in crashes or terminations that impede smooth operations continuity. For example, in traditional auxiliary physical storage systems the approach to memory errors is to reboot the system. Rebooting from a system crash due to a memory error is very inconvenient, usually results in wasting significant resources and significantly increasing the probability of data corruption. Traditional memory error failure modes often result in lost information and delays incurred during the reboot process waste time.

The traditional reboot approach to clearing memory errors often results in a looping reboot process that is particularly troublesome and detrimental in the event of a hard or unrecoverable error. For example, in traditional auxiliary memory systems that utilize a memory controller cache to act as a buffer for information as it is communicated to and from the physical memory, the system enters a loop cycle involving repetitive error recognitions and attempted cache flushes. When a memory error occurs a reboot cycle is initiated and the system determines if there is memory controller cache data waiting to be written to the physical disk. The existence of memory controller cache data waiting to be written to the physical disk is utilized to indicate the boot process is a warm boot and it attempts to flush out the memory controller cache or “buffers”. However, as soon as the system begins an attempted flush, the error triggers the initiation of the reboot process again resulting in a continuous reboot cycle.

Traditional auxiliary memory systems have no or very limited memory error detection provisions such as parity checking. When the prior art encounters indications of data corruption the results are usually not graceful (e.g., rebooting the system) and leave a significant number of data corruption issues unresolved. Even when a traditional system manages to reboot the information included in the physical disk is often corrupted and inaccurate. In addition, the information in the host and the physical disk usually becomes out of sync (not coherent). For example, information in a host system main memory (e.g., a random access memory cache) never gets stored in the physical disk and the host operates as if the information has already been written to the disk. In this situation there is an incoherent condition between the host and the physical storage memory (media). The inconsistency can not be corrected since the information in the main memory is not pushed out to the physical media to get it synched up because every time there is a startup the system reboots. Traditional memory system error failure modes often lack desirable memory error fault tolerance features and do not provide sufficient fail safe environment characteristics such as smooth operation continuity.

### SUMMARY

The present invention is a computer memory error management system and method that facilitates fault tolerant memory input and output operations in a manner that permits smooth and continuous operations. A present invention computer memory error management system and method corrects memory errors and handles memory control buffer corruption concerns. In one embodiment of the present invention, a determination is made if an error exists in information read from a memory buffer controller and if the error is correctable (e.g., a single bit error) or non-correctable (e.g., a multi-bit error). Correctable errors are corrected inline. A memory cell error resolution process is performed to ensure that information in a memory control location does not cause data corruption or synchronization problems. In one embodiment of the present invention, a memory cell error resolution process comprises software algorithms included in an interrupt service routine management protocol that controls information rewriting to a memory control buffer location.

In one exemplary implementation, the memory control buffer location is refreshed (e.g., rewritten) with corrected information and if this does not resolve the error problems the information is rewritten to a different memory control buffer location. In one embodiment of the present invention, a memory controller fail over process is utilized and an alternate memory control buffer takes over master responsibilities associated with a memory input/output operation. Eventually the memory input output operations are completed without causing a system crash or leaving corrupted data in a controller memory buffer location.

### DESCRIPTION OF THE DRAWINGS

FIG. 1 is a flow chart of memory error management method, one embodiment of the present invention.

FIG. 2 is a block diagram illustration of a memory error management computer system, one exemplary system for implementing methods of the present invention.

FIG. 3 is a block diagram of one embodiment of a present invention memory controller.

FIG. 4 is a flow chart of a memory cell error resolution process utilized in one embodiment of the present invention.

FIG. 5 is a flow chart of one embodiment of a present invention error fail-over process.

FIG. 6 shows a flow chart of a memory cell error resolution process, one embodiment of a present invention memory cell error resolution process that addresses asynchronous error concerns.

FIG. 7 is a continuation of the FIG. 6 flow chart of a memory cell error resolution process, one embodiment of a present invention memory cell error resolution process that addresses asynchronous error concerns.

FIG. 8 is a block diagram of a recursive error handling process, one embodiment of a present invention recursive error handling process.

FIG. 9 is a continuation of the block diagram shown in FIG. 8 of a recursive error handling process, one embodiment of a present invention recursive error handling process.

FIG. 10 is a flow chart of another memory cell error resolution process demonstrating the flexibility of the present invention.

FIG. 11 is continuation of FIG. 10 showing a flow chart of another memory cell error resolution process demonstrating the flexibility of the present invention.

### DETAILED DESCRIPTION

Reference will now be made in detail to the preferred embodiments of the invention, a computer memory error management system and method, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within an electronic system. These descriptions and representations are the means used by those skilled in the digital arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in the electronic system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise or as apparent from the following discussions, it is appreciated that throughout the present invention, discussions utilizing terms such as “processing”, “computing”, “calculating”, “determining”, “displaying”, or the like, refer to the action and processes of an electronic device that manipulates and transforms data represented as physical (electronic) quantities within the system (e.g., within registers, logic gates, memories, etc.) into other data similarly represented as physical quantities within the system devices or other such information storage, transmission or display devices.

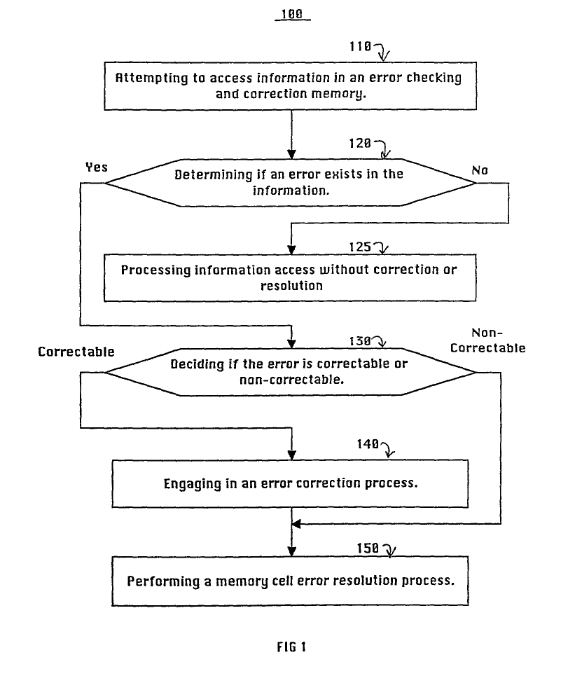

FIG. 1 is a flow chart of memory error management method 100, one embodiment of the present invention. Memory error management method 100 facilitates fail-safe management of recoverable memory errors and non-recoverable memory errors. In one embodiment of the present invention, memory error management method 100 is implemented in firmware that creates a fail-safe environment tolerant of memory errors that would otherwise cause an error correction code hardware driven interrupt to initiate a reboot operation. In one exemplary disk array memory system implementation of the present invention, memory error management method 100 enables fault tolerant management of disk array controller cache memory errors, including correction of single bit errors.

In step 110, an attempt is made to access (e.g., read) information from an error checking and correction memory. In one embodiment of the present invention, the error checking and correction memory is an error correction code (ECC) memory utilized as a memory controller buffer (e.g., a memory controller cache of a disk array memory system). In one exemplary implementation of the present invention, the information is a plurality of bits (e.g., electrical signals representing logical ones and zeroes) included in a memory controller buffer location (e.g., a cell). The present invention is readily adaptable to a variety of implementations, for example a memory controller buffer location may include a word comprising four bytes (32 bits) of information, two bytes (16 bits), eight bytes (64 bits), etc.

In step 120, a determination is made if an error exists in the information. In one embodiment of the present invention an error checking process is performed. For example, an ECC process is utilized in which the comparison of computed check bits and check bits inserted in the information provides an indication of an error. If an error does exists the process skips to step 130. If an error does not exist the process proceeds to step 125.

If an error does not exist, the process permits the access to proceed in step 125 without performing any error correction or resolution.

In step 130, an examination is made to ascertain if the error is a correctable error or non-correctable error. In one embodiment of the present invention, single bit errors are correctable and multi-bit errors are not correctable. In another embodiment of the present invention, an algorithm compares the error to a table mapping correctable errors (e.g., single bit error and select multi-bit errors) and non-correctable errors (e.g., remaining error types). If the error is a correctable error the process proceeds to step 140. If the error is a non-correctable error the process proceeds to step 150.

An error correction process is engaged in step 140. The error correction process corrects the errors inline as the information is accessed (e.g., during the data's transfer return to a PCI bus). In one embodiment of the present invention, an exclusive OR (XOR) array technique is utilized to correct an error. For example, an XOR array utilizing hamming code techniques and syndrome comparisons participates in error bit correction. Memory error management method 100 proceeds to step 150 to resolve memory location discrepancies that may exist even through an error is corrected inline in step 140. The memory location error resolution process facilitates minimization of data corruption and inconsistency problems.

In step 150, a memory location error resolution process is performed. In one embodiment of the present invention, a memory location error resolution process comprises software algorithms that participate in an interrupt service routine management protocol. The memory location error resolution process facilitates minimization of fault crashes and system memory coherency problems in a manner that increases smoother operational continuity (e.g., fewer potential reboot conditions). In one embodiment of the present invention, a memory cell error resolution process includes rewriting information to a memory control buffer location. In one exemplary implementation, the memory control buffer location is refreshed with corrected information and if this does not resolve the error problems, information is rewritten to a different memory control buffer location. In one embodiment of the present invention, a memory controller fail over process is utilized and an alternate memory controller takes over master responsibilities associated with an overall memory input/output operation.

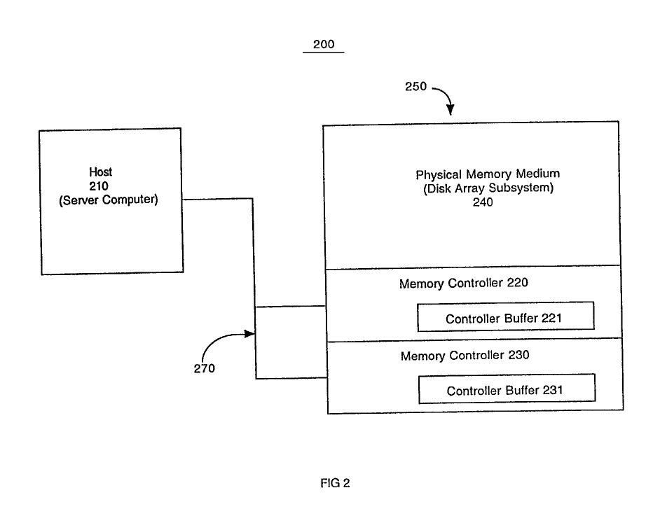

FIG. 2 is a block diagram illustration of memory error management computer system 200, one exemplary system for implementing methods of the present invention. Memory error management computer system 200 comprises a host 210 and memory device 250. In one embodiment of the present invention memory device 250 is a peripheral or an auxiliary memory device (e.g., a disk array storage system). Memory device 250 includes physical memory medium 240 (e.g., a disk array subsystem), a first memory controller 220 and a second memory controller 230. Memory controller 220 and memory controller 230 include memory controller buffers 221 and 231 respectively. In one embodiment of the present invention, memory controller buffers 221 and 223 are caches. Host 210 is coupled to memory controllers 221 and 231 which are coupled to physical memory medium 240. In one exemplary implementation of the present invention, host 210 is a server computer system that provides access and services to other computers (not shown).

The components of memory error management computer system 200, cooperatively operate to store, communicate and process information while efficiently managing memory errors that occur during the communication of information. Host 210 executes processing operations that provide and receive information to and from memory device 250. Memory storage device 250 stores information while providing memory fault tolerant error management. Information communicated between host 210 and memory storage device 250 is routed via a memory controller. For example, memory controller 220 and memory controller 230 provide an information communication interface that handles memory error resolution and memory error correction of correctable errors (e.g., single bit errors).

Referring still to FIG. 2, information communicated between physical memory medium 240 and host server computer system 210 is routed via controller buffers 221 and 231. In one exemplary implementation, overall memory input/output (I/O) operations involve host 210 writing and reading information to and from the physical memory medium 240. In order to perform the overall input/output operations information is sent (e.g., written) to and received (e.g., read) from at least one of the control buffers 221 or 231. Memory error management is performed when communicating (e.g., reading) the information from the controller buffers 221 or 231 to either the host 210 or the physical memory medium 240.

In one exemplary implementation, information is written to and read from a control buffer (e.g., 221 or 231) during an overall memory I/O operation. An overall memory I/O write operation of information to physical memory medium 240 (e.g., from host 210 to physical memory medium 240) involves a write (e.g., from host 210) to a master controller buffer (e.g., either 221 or 231) and a read from the master controller buffer to physical memory medium 240 when ready. An overall memory I/O read operation of information included in physical memory medium 240 (e.g., from physical memory medium 240 to host 210) involves a read from a master controller buffer (e.g., either 221 or 231) to another device (e.g., host 210). Memory controller 221 or memory controller 231 acting as the master may or may not retrieve (e.g., read) the information from the physical memory medium (e.g., because the information may already be in the buffers). If the memory controller 221 or 231 acting as the master retrieves (e.g., reads) the information from the memory storage medium 240, the information is written to the master controller buffer.

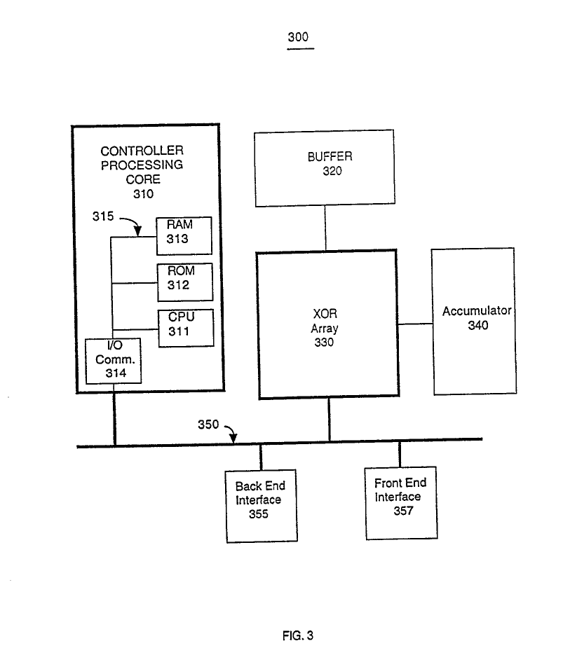

FIG. 3 is a block diagram of memory controller 300 one embodiment of a present invention memory controller (e.g., memory controller 221). Memory controller 300 comprises controller processing core 310, controller buffer 320, XOR array 330, accumulator 340, backend interface 355, front end interface 357 and communication bus 350. Communication bus 350 is coupled to controller processing core 310, backend interface 355, front end interface 357 and XOR array 330 which is coupled to controller buffer 320 and accumulator 340. In one exemplary implementation of the present invention, controller processing core 310 comprises central processing unit (CPU) 311 for processing memory controller instructions, a non-volatile memory 312 (e.g., a read only memory ROM) for storing static information for CPU 311, volatile memory 313 (e.g., a random access memory RAM) for storing information for CPU 311, input and output (I/O) communication interface 314 (e.g., a peripheral component interconnect (PCI) bridge) communicates information and address data bus 315 for communicating information between components within controller processing core 310.

The components of memory controller 300 cooperatively operate to facilitate fault tolerant memory error management. Controller processing core 310 directs the operations of memory controller 300. In one embodiment of the present invention, controller processing core 310 is utilized as a platform to implement present invention memory error management processes (e.g., a memory cell error resolution process of step 150). Buffer 320 stores information being communicated by memory controller 300 (e.g., between a host and physical memory medium). Logical exclusive or (XOR) array 330 provides correction of single bit errors. The correction is performed inline as the data is process through direct memory access (DMA) to a front end or back end interface. Accumulator 340 stores information associated with the logic and arithmetic operations of the XOR array. Back end interface provides a communications interface to back end devices (e.g., a memory storage medium). Front end interface provides a communications interface to front end devices (e.g., a host). Communication bus 350 communicates information between the components of memory controller 300.

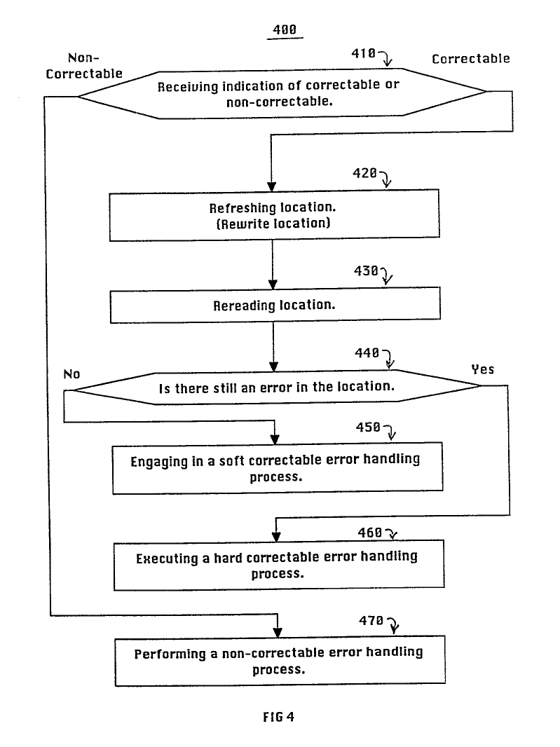

FIG. 4 is a flow chart of memory cell error resolution process 400. Memory cell error resolution process 400 is one embodiment of a memory cell error resolution process utilized in step 150 of memory error management method 100 shown in FIG. 1. Memory cell error resolution process 400 facilitates resolution of information errors in a memory controller buffer (e.g., memory controller buffer 221). In one embodiment of the present invention, memory cell error resolution process prevents corrupted information in a memory controller buffer from causing synchronization and incoherency problems between a host and a physical memory storage medium.

In step 410, an indication of a correctable or non-correctable error occurrence is received. In one embodiment of the present invention, the indication is provided by an earlier determination that an error exists in the information (e.g., step 120) and decision if an error is a correctable or non-correctable error (e.g., step 130). If the error is non-correctable the process proceeds to step 470. If the error is a correctable error the process proceeds to step 420.

At step 420, a memory controller buffer refreshing process is performed in which information is re-entered into a memory controller buffer location (e.g., cell). In one embodiment of the present invention, a controller buffer refreshing process is utilized to handle original data with an error that still exists in the memory controller buffer even though the error is corrected inline on its way out of the memory controller buffer. The refreshing is an attempt to enter correct (e.g., error free information) into the location. Entering the correct information into a location reduces the probability of multiple reads of the location presenting the same error, diminishes the probability of a deterioration to multi-bit errors, facilitates data corruption minimization and decreases data consistency problems. In one embodiment of the present invention, the memory controller buffer refreshing process is performed by software handling within an interrupt service routine (ISR). In one exemplary implementation of the present invention, corrected information is rewritten into the location (e.g., cell) of the memory controller buffer that had an error in an attempt to provide the correct (e.g., error free) value. Writing the information back to the same location in the memory controller buffer “refreshes” that location.

A reread operation of the memory controller location is performed in step 430.

A determination is made if an error still exists in step 440. In one embodiment of the present invention an error checking process similar to the process utilized in step 120 is performed. For example, an ECC process is utilized in which the comparison of computed check bits and check bits inserted in the information provides an indication of an error. If an error does exist the process skips to step 460. If an error does not exist the process proceeds to step 450.

At step 450, a soft correctable error handling process is engaged. Most of the error concerns associated with a soft correctable bit error are already “handled” at this point. For example, the memory buffer location has been refreshed and there is no longer an error in the location. Essentially, a soft correctable error handling process “designates” an error as soft and the system considers the overall memory I/O operation as complete. In one exemplary implementation of the present invention, a soft error handling process collects information associated with soft errors. For example, a soft error handling process increments a soft error count (e.g., a report is made to a system log with log level LOG_INFO) that is accessible by an authorization procedure (e.g., to a service technician). In one embodiment of the present invention, a soft error handling process automatically signals an operator and in another embodiment it does not automatically signal an operator.

In step 460, a hard correctable error handling process is executed. In one embodiment of the present invention, a hard error handling process includes an error fail-over process which utilizes resources of a different or alternate memory controller buffer. In one exemplary implementation, the first master memory controller (e.g., memory controller 220) conveys master control over to a second memory controller (memory controller 230) and the second memory controller attempts to complete the overall memory I/O operations. The overall memory I/O operations that cause the original error are treated as complete since the error was auto-corrected (e.g., in step 140). In one embodiment of the present invention, a hard correctable error handling process automatically signals an operator of the hard error. In one exemplary implementation of the present invention, information associated with hard errors is collected (e.g., a hard error handling process increments a hard error count). In one embodiment of the present invention, a message is sent to the system log (e.g., log_level set to LOG_Warning).

In step 470, a non-correctable error handling process is performed. In one embodiment of the present invention, the initial memory controller that had control when an overall memory I/O operation resulted in a memory error retains control and the non-correctable process involves “fencing” off a location (e.g., a cell) of a memory controller buffer and forwarding the information to another location within a memory controller buffer. In one embodiment of the present invention, a non-correctable error bit handling process includes an error fail-over process which utilizes resources of a different or alternate memory controller buffer. For example, the initial memory controller that had control when a memory I/O operation resulted in a memory error relinquishes control to another memory controller and the “new” master memory controller attempts to complete the I/O operation.

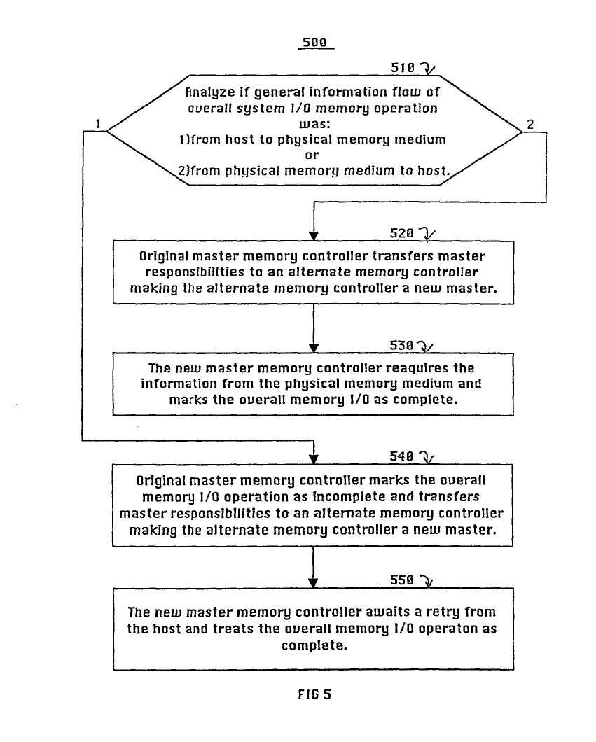

FIG. 5 is a flow chart of error fail-over process 500, one embodiment of a present invention error fail-over process. In one exemplary implementation of the present invention, error fail-over process 500 is utilized to perform a fail over process in steps 460 or 470 of memory cell error resolution process 400. Error fail-over process 500 provides a smooth and efficient method of passing master control responsibilities from one memory controller (e.g., one memory controller 221) to an alternate memory controller (e.g., one memory controller 231).

In step 510, an analysis is performed to examine if the general information flow of an overall memory I/O operation is from a host to a physical memory medium or from a physical memory medium to a host. If the general information flow of an overall memory I/O operation is from a host to a physical memory medium the process skips to step 540. If the general information flow of an overall memory I/O operation is from a physical memory medium to a host the process proceeds to step 520.

The original master controller transfers master responsibilities to an alternate memory controller making the alternate memory controller a new master at step 520.

In step 530 the new master memory controller re-aquires the information from the physical memory medium and the overall memory I/O operation is treated as complete.

At step 540, the original master controller transfers master responsibilities to an alternate memory controller making the alternate memory controller a new master and the overall memory I/O is treated as incomplete.

In step 550, the new master memory controller awaits a retry from the host and after the new master performs the overall memory I/O operation it is treated as complete.

In one embodiment of the present invention, an initial memory controller retains master control for non-correctable errors. A determination is made if the information causing the error was read from a memory storage medium or a host. If the information causing the error was read from a memory storage medium, then the memory controller reads the information again from the memory storage unit and writes it to a different location within its own memory controller buffer. If the information causing the error was read from a host, the information is read from a buffer location of an alternate memory controller buffer (e.g., 231) and written into a different location within its own memory controller buffer (e.g., 221). In an alternative embodiment of the present invention, when the information causing the error was read from a memory storage medium (e.g., memory storage medium 240) the memory controller reads the information from a buffer location of an alternate memory controller buffer (e.g., 231) and written into a different location within its own memory controller buffer (e.g., 221).

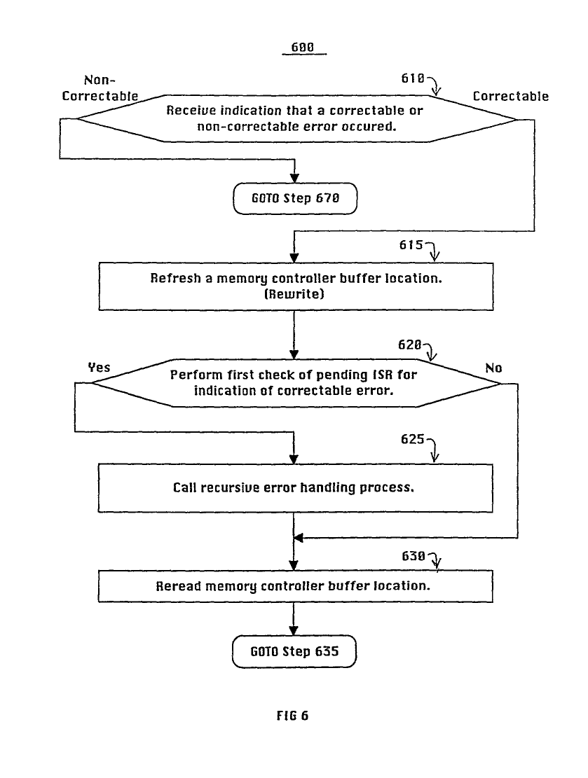

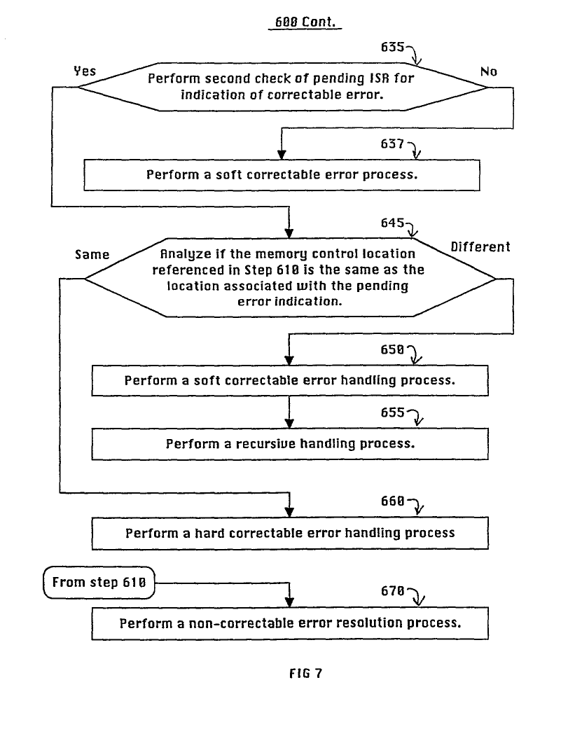

The present invention is readily adaptable to a variety of implementations that are responsive to different maximizing objectives. For example, FIGS. 6 and 7 show a flow chart of memory cell error resolution process 600. Memory cell error resolution process 600 is similar to memory cell error resolution process 400 except memory cell error resolution process 600 includes provisions for handling “asynchronous” memory errors. For example, memory cell error resolution process 600 has provisions to deal with memory errors that are the result of overlapping memory I/O events such as read operations that overlap at least partially an “original” read operation”. Memory cell error resolution process 600 handles these overlapping events recursively by starting new error handling process functions. A new error handling process function handles the asynchronous error resolution.

In step 610, an indication of a first correctable or non-correctable error occurrence is received. If the error is a non-correctable error the process proceeds to step 670. If the error is a correctable error the process proceeds to step 615.

At step 615, a memory controller buffer refreshing process is performed in which information is re-entered into a memory controller buffer location (e.g., cell) that started the present error handling process. Step 615 is similar to step 420.

At step 620 a first check for a pending ISR indication of a correctable error is performed. In one embodiment of the present invention, a first check for a pending ISR indication of a correctable error checks for an asynchronous error. An asynchronous error is an error associated with a different overall memory input output operation that is attempted “asynchronously”, while the memory cell error resolution process 600 is resolving an original error. For example, an error associated with a different overall memory input output operation from the original overall memory input output operation that had an error (e.g., associated with indication received in step 610). If there is not a pending ISR indication of a correctable error the process jumps to step 630. If there is a pending ISR indication of a correctable error the process proceeds to step 625.

At step 625 the process proceeds to perform a recursive error handling process. When control is returned from the recursive error handling process, memory cell error resolution process 600 proceeds to step 630. In one embodiment of the present invention the recursive error handling process goes to step 615 and processes the asynchronous error associated with the pending indication from step 620. When completed with the asynchronous error associated with the pending indication from step 620, the original processing associated with the correctable error indication from step 610 proceeds to step 630. In one embodiment of the present invention, the recursive error handling process is performed as a “push” in which processing handling the asynchronous error associated with the pending indication from step 620 is deferred until after the original processing associated with the correctable error indication from step 610.

In step 630, a reread operation of the memory controller location refreshed in step 615 is performed.

In step 635 a second check for a pending ISR indication of a correctable error is performed. In one embodiment of the present invention, the second check for a pending ISR indication of a correctable error also checks for an asynchronous error. If there is not a pending ISR indication of a correctable error the process proceeds to step 637. If there is a pending, ISR indication of a correctable error the process jumps to step 645.

In step 645, an analysis is performed to examine if the memory control buffer location associated with the error indicated in step 610 is the same as the locations associated with steps 620 and 635. If the memory control buffer locations are the same the process skips to step 660. If the memory control buffer locations are different the process proceeds to step 650.

In step 650 a soft correctable error handling process is engaged. At the completion of the soft correctable error handling process the process proceeds to step 655.

At step 655, the process proceeds to perform a recursive error handling process. When control is returned from the recursive error handling process memory cell error resolution process 600 ends since the original error was handled in step 650.

In step 660 a hard correctable error handling process is executed.

In step 670 a non-correctable error handling process is executed.

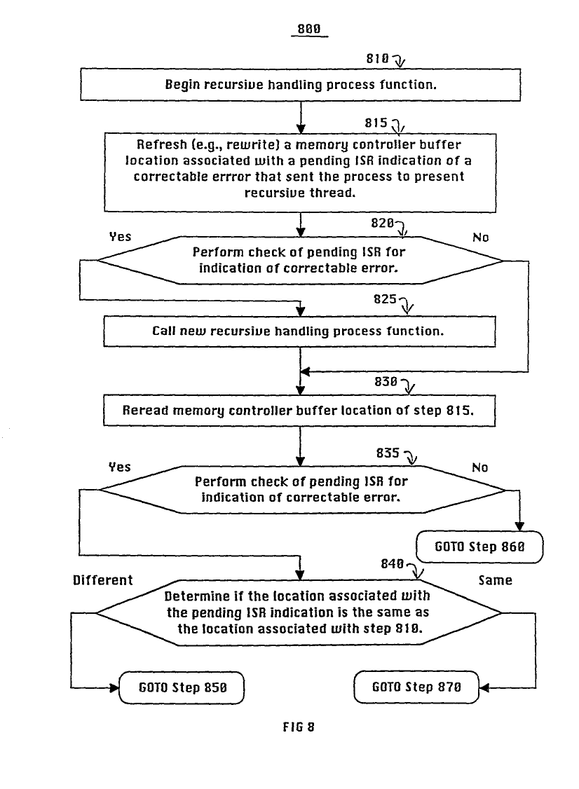

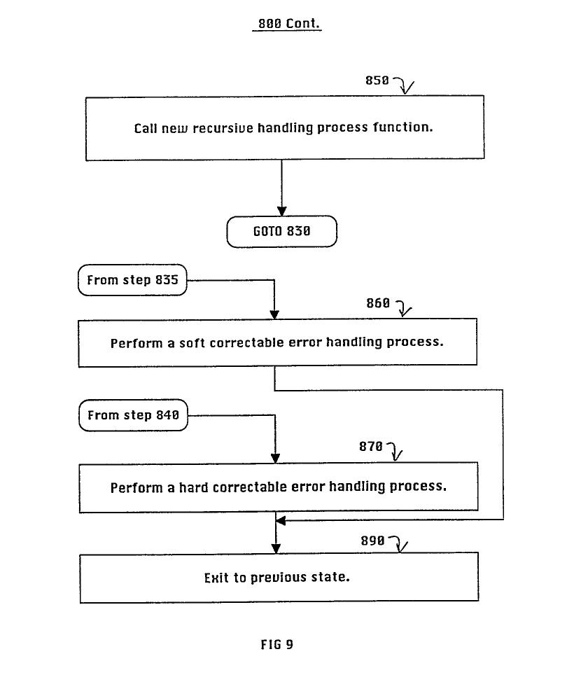

FIGS. 8 and 9 are block diagrams of recursive error handling process 800, one embodiment of a present invention recursive error handling process. In one embodiment of the present invention, recursive error handling process 800 engages in repeatedly performing new recursive error handling process functions for each asynchronous indication of a pending error until each error is successfully handled.

In step 810, a recursive handling process is begun. In one exemplary implementation of the present invention, a recursive error handling process is initiated at the direction of a memory cell error resolution process (e.g., step 625 or step 640 of memory cell error resolution process 600).

In step 815 a refresh of a memory controller buffer location associated with a pending ISR indication that sent the process to the present recursive function.

At step 820, a first check for a pending ISR indication of a correctable error is performed. If there is not a pending ISR indication of a correctable error the process jumps to step 830. If there is a pending ISR indication of a correctable error the process proceeds to step 825.

At step 825, the process proceeds to perform a recursive error handling process. In one exemplary implementation of the present invention, the process begins a new error handling function which essentially begins at a step similar to step 810 except it is a new error handling function that handles the asynchronous error indication from step 820. When control is returned from the “new” recursive error handling process memory cell error resolution process 800 proceeds to step 830.

In step 830, a reread operation is performed on the memory controller location refreshed in step 815.

In step 835, a second check for a pending ISR indication of a correctable error is performed. In one embodiment of the present invention, the second check for a pending ISR indication of a correctable error also checks for an asynchronous error. If there is not pending ISR indication of a correctable error the process proceeds to step 860. If there is a pending ISR indication of a correctable error the process proceeds to step 840.

In step 840 a determination is made if the location of a pending ISR indication of a correctable error in step 835 is the same location associated with pending ISR indication of a correctable error in step 810. If the address is the different the process proceeds to step 850. If the address is different the same process proceeds to step 870.

At step 850, the process proceeds to performs a recursive error handling process to handle the error indicated in step 835. When control is returned from the “new” recursive error handling process memory cell error resolution process 800 goes to step 830.

In step 860 a soft correctable error handling process is performed.

In step 870 a hard correctable error handling process is performed.

In step 890 the process exits to a previous state. In one embodiment of the present invention the process returns to an error handling function that initiated the present function (e.g., step 625 or step 640 of memory cell error resolution process 600).

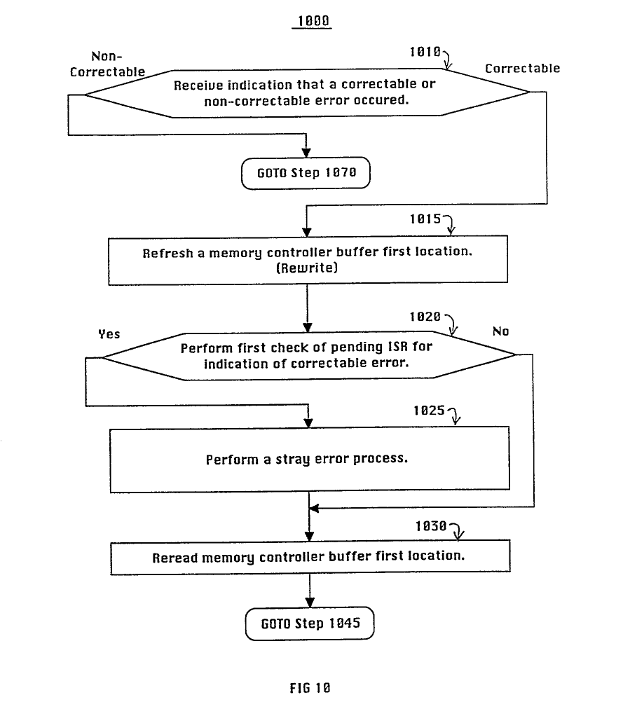

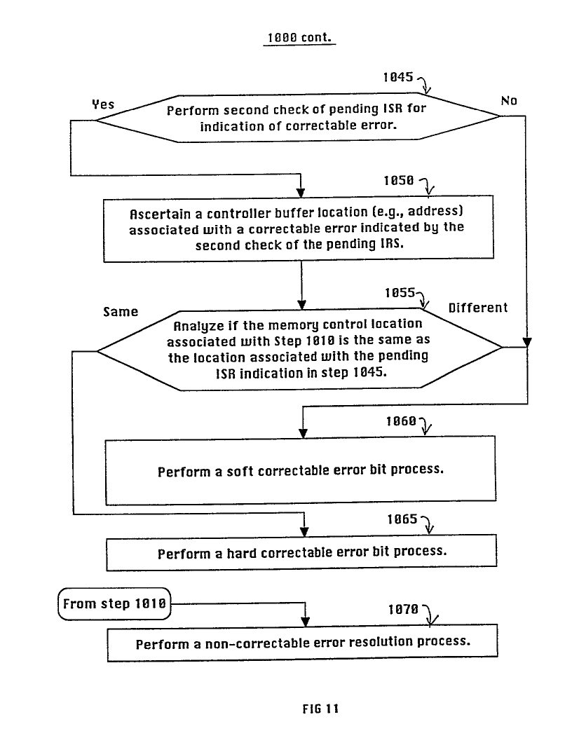

FIGS. 10 and 11 show a flow chart of memory cell error resolution process 1000, another embodiment demonstrating the flexibility of a present invention memory cell error resolution process. Memory cell error resolution process 1000 is similar to memory cell error resolution process 400, except memory cell error resolution process 1000 includes provisions for handling “asynchronous” memory errors. Memory cell error resolution process 1000 facilitates a balancing of overall system ISR timing concerns with resolution of asynchronous errors. In one exemplary implementation of memory cell error resolution process 1000, fewer checks of pending ISR indications of errors are initiated and discovered errors are not entered into repeatedly recursive steps as indicated in memory cell error resolution process 600. Rather memory cell error resolution process 1000 treats an asynchronous error as a soft error and if the error is truly a hard error memory cell error resolution process 1000 effectively “defers” that determination for a future read of the location in which an asynchronous pending error condition does not arise.

An indication of a first correctable or non-correctable error occurrence is received in step 1010. If the error is non-correctable the process proceeds to step 1070. If the error is a correctable error the process proceeds to step 1015.

At step 1015, a memory controller buffer refreshing process is performed in which information is re-entered into a memory controller buffer location (e.g., cell).

At step 1020, a first check for a pending ISR indication of a correctable error is performed. If there is not a pending ISR indication of a correctable error the process jumps to step 1030. If there is a pending ISR indication of a correctable error the process proceeds to step 1025.

In step 1025, an asynchronous error process is performed. In one embodiment of the present invention, a memory controller buffer location (e.g., address) associated with a correctable error indicated by the first check of the pending ISR is ascertained in step 1020 and the asynchronous error is processed as a soft error. In one exemplary implementation, a correctable error count and a soft error count are incremented.

In step 1030, a reread operation of the memory controller first location is performed.

In step 1045 a second check for a pending ISR indication of a correctable error is performed. If there is not a pending ISR indication of a correctable error the process jumps to step 1060. If there is a pending ISR indication of a correctable error the process proceeds to step 1050.

A memory controller buffer location (e.g., address) associated with a correctable error indicated by the second check of the pending ISR is ascertained in step 1050. In one embodiment of the present invention the error associated with the indication in step 1045 is treated as a soft error and changes to the information (e.g., a refresh, fetch again from a memory storage medium, etc.) in the buffer location are “deferred” for a later access (e.g., read) attempt. In one exemplary implementation a correctable error count and a soft error count are incremented.

In step 1055 an analysis is performed to examine if the memory control buffer location associated with the error indicated in step 1010 is the same as the locations ascertained in step 1050. If the memory control buffer locations are the same the process skips to step 1065. If the memory control buffer locations are different the process proceeds to step 1060.

In step 1060 a soft correctable error handling process is engaged.

In step 1065 a hard correctable error handling process is implemented.

In step 1070 a non-correctable error handling process is performed.

In one embodiment of the present invention, a non-recoverable or hard recoverable error results in a system reset. In one exemplary embodiment, the present invention is implemented in a single controller environment (e.g., a single brick controller configuration) and if a non-recoverable or hard recoverable error occurs the system resets.

In one embodiment of the present invention, information associated with errors is utilized in a predictive failure analysis process. In one exemplary implementation, the results of a present invention predictive failure analysis process are utilized in decisions associated with preventative maintenance. For example, if a memory controller buffer reaches a particular number of hard errors or a pattern of hard error occurrences are detected by the present invention an indication is provided that maintenance is suggested (e.g., replacing the memory controller or memory controller buffer). In one embodiment of the present invention a predictive failure analysis process utilizes information associated with soft errors (e.g., frequent occurrence in the same location) to make decisions associated with fencing off particular locations.

In one exemplary implementation, the present invention also addresses accumulator memory concerns. When a correctable error is detected and an XOR array is performing functions associated with the accumulator, the firmware response is different than that related to the memory controller buffer operations. The firmware (e.g., XOR ISR) passes the information (e.g., error statistics) up to a higher level function. The higher level function invalidates the accumulator block. After the invalidation, the accumulator block is re-used. The invalidation recreates the parity stripe and the re-use refreshes the accumulator memory.

The present invention is readily adaptable to a variety of implementations and timing sequences. For example, recursive error handling functions can be implemented in a sequential fashion or a push fashion. In one embodiment of the present invention the recursive error handling process returns to a previous refresh operation and processes the asynchronous error associated with a pending indication. When completed with the asynchronous error associated with the pending indication, the original processing associated with the initial correctable error indication continues. In one embodiment of the present invention, the recursive error handling process is performed as a “push” in which processing handling the asynchronous error associated with the pending indication is deferred until after the original processing associated with the correctable error indication.

In one embodiment of the present invention, the recursive error handling process is a separate sub-function with different characteristics. For example, a process may start out similar to memory cell error resolution process 600 and for a recursive error handling process call a recursive error handling process similar to recursive error handling process 800 or it can call one similar to memory cell error resolution process 1000 that balances recursiveness with operational constraints (e.g., impacts on ISR operations).

Thus, the present invention facilitates correction and resolution of errors that have detrimental impacts on the operations and functionality of systems utilizing error checking and correction memories. A present invention memory error management system and method handles memory errors without immediate defaults to crashes or terminations that impede smooth operational continuity. For example, the present memory error management system and method does not instantaneously default to a traditional auxiliary physical storage system approach of rebooting the system in response to memory errors. The present invention gracefully handles memory error corruption concerns and hard memory errors without resulting in a looping reboot process that is particularly troublesome and detrimental. The present invention system and method includes desirable memory error fault tolerance features and provides sufficient fail safe environment characteristics such as smooth operation continuity.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. A memory error management method comprising:
attempting to access information in an error checking and correction memory;
determining if an error exists in the information;
deciding if an error is correctable or not correctable;
engaging in an error correction process; and
performing a memory cell error resolution process.

2. The memory error management method of claim 1 wherein said information is a plurality of bits in a memory controller buffer cell.

3. The memory error management method of claim 1 wherein said error checking and correction memory is a memory controller buffer of a disk array memory system.

4. The memory error management method of claim 1 wherein said error correction process is a single bit error correction code process that corrects a single bit error inline.

5. The memory error management method of claim 1 wherein a hamming code and error syndrome is utilized to correct a bit in error.

6. The memory error management method of claim 1 wherein said memory cell error resolution process includes rewriting information to a memory control buffer location.

7. The memory error management method of claim 1 wherein said memory cell error resolution process includes rewriting corrected information to a memory controller buffer location and if said rewriting resolves the error a soft correctable error count is incremented.

8. The memory error management method of claim 1 wherein said memory cell error resolution process includes a memory controller fail over process in which an alternate memory controller buffer takes over master responsibilities associated with an overall memory input/output operation.

9. A memory controller comprising:
a communication bus for communicating information between components of said memory controller;
a controller processing core for directing operations of said memory controller and providing a platform to implement a memory error management process, said controller coupled to said communication bus;
an XOR array for providing correction of single bit errors, said XOR array coupled to said communications bus;
a memory controller buffer for storing information being communicated by said memory controller between a host and a physical memory medium, said controller buffer coupled to said XOR array;
a backend interface for providing a communications interface to back end components, said backend interface coupled to said communications bus; and
a front end interface for providing a communications interface to front end components, said front end interface coupled to said communications bus.

10. A memory controller of claim 9 wherein an error is detected at a location within said memory controller buffer and said controller processing core directs rewriting information to said location and rechecking for an error in said location.

11. A memory controller of claim 10 wherein said controller processing core directs a reread of information from a physical memory medium and the reread information is utilized in said rewrite to said location.

12. A memory controller of claim 10 wherein said controller processing core fences off said location and rewrites said information to a different location within said memory controller buffer.

13. A memory controller of claim 9 wherein an error is detected and said controller processing core relinquishes responsibility for master control operations to an alternate memory controller.

14. A memory controller of claim 13 wherein an overall memory input/output operation that resulted in said error is treated as not complete and said processing core relinquishes responsibility for master control operations to an alternate memory controller that completes said overall memory input/output operation

15. A memory controller of claim 9 wherein said controller processing core receives responsibility for master control operations from another memory controller and processes a memory input/output operation request that produced an unrecoverable error.

16. A memory controller of claim 9 further comprising an accumulator for storing information associated with the logic and arithmetic operations of said XOR array, said accumulator coupled to said XOR array.

17. The memory controller of claim 7 wherein said controller processing core directs tracking of error information including counts of soft correctable errors, hard correctable errors and non-correctable errors.

18. A memory error resolution process comprising:
receiving information indicating whether an error is a correctable error or a non-correctable error;
performing a memory controller buffer refreshing process;
engaging in a correctable error handling process; and
performing a non-correctable error handling process.

19. A memory error resolution process of claim 18 wherein said memory controller buffer refreshing process comprises re-entering corrected information into said memory controller buffer location.

20. A memory error resolution process of claim 19 wherein a soft correctable error handling process is engaged if no errors exist after said re-checking information in said memory controller buffer.

21. A memory error resolution process of claim 20 wherein a soft correctable error handling process comprises tracking soft correctable error information including incrementing a soft error correctable count.

22. A memory error resolution process of claim 19 wherein a hard correctable error handling process is implemented if an errors exist after said re-checking information in said memory controller buffer, said hard correctable error handling process includes an error fail-over process that utilizes resources of a different or alternate memory controller buffer

22. A memory error resolution process of claim 19 wherein said non correctable error handling process comprises:
fencing off of a memory controller buffer location; and
forwarding the information to another location within a memory controller buffer.

23. A memory error resolution process of claim 19 wherein said non-correctable error handling process comprises an error fail-over process in which an initial memory controller that had control when a memory I/O operation resulted in a memory error relinquishes control to an alternate memory controller and said alternate memory controller attempts to complete said memory I/O operation.

24. A memory error resolution process of claim 18 further comprising performing a recursive error handling process.

25. A memory error resolution process of claim 18 further comprising performing a predictive failure analysis process.
